(19) United States
(12) Patent Application Publication
(10) Pub. No.: US 2008/0069277 A1
(43) Pub. Date: Mar. 20, 2008

(54) Method and apparatus for modeling signal delays in a metastability protection circuit

(76) Inventors: Gzim Derti, Schnecksville, PA (US); Carl R. Holmqvist, Bangor, PA (US); Harold J. Wilson, Center Valley, PA (US)

Correspondence Address: RYAN, MASON & LEWIS, LLP, 1300 POST ROAD, SUITE 205, FAIRFIELD, CT, 06824, US

(21) Appl. No.: 11/522,740

(22) Filed: Sep. 18, 2006

(51) Int. Cl. H04L 7/00

(52) U.S. Cl. 375/354

(57) ABSTRACT

Methods and apparatus are provided for modeling signal delays in a metastability protection circuit. A metastability protection circuit that processes a signal that crosses between two clock domains is modeled by introducing a random transition delay into the signal upon detection of an edge in the signal. Thereafter, an effect of the random transition delay on one or more downstream logic elements can be evaluated. The random transition delay simulates a timing effect of a metastable state. The random transition delay can optionally be introduced only during a simulation stage of the metastability protection circuit. For example, the metastability protection circuit can be defined using a Register Transfer Language and the Register Transfer Language includes one or more statements that selectively allow the introducing step.

### FIELD OF THE INVENTION

The present invention is related to techniques for simulating a metastability protection circuit and, more particularly, to techniques for simulating a random transition delay in a metastability protection circuit.

### BACKGROUND OF THE INVENTION

In many electronic circuits, data signals from one device need to be delivered to another device. For example, data signals from a particular chip or application-specific integrated circuit (ASIC) may be delivered via appropriate interconnects to another chip. In a further variation, incoming data may need to cross from a launching clock domain, to a receiving clock domain. A problem that arises in such a multiple chip environment or a single chip environment with multiple clock domains is that the clock signals of the first and second clock domains may be different frequencies or even if they have the same frequency, the phase relationship between these clock signals is often unknown, i.e., the clock signals are asynchronous. This can lead to other significant problems, such as a violation of minimum setup and hold times in the second chip, or metastability. Metastability occurs when an undefined or unpredictable voltage state exists between either predefined binary logic value. Generally, if there is a change in the data value close to a clock edge, a metastable state can occur (where there is an unpredictable metastable output between 0 and 1).

A number of techniques have been proposed or suggested for preventing a metastable state in an asynchronous environment. For example, one well-known technique provides one or more flip flops in the design to synchronize the incoming asynchronous signal with the new clock domain. In this manner, the additional flip flops are said to reduce the Mean-Time-Between-Failure (MTBF). For example, one or more D type flip-flops can be employed to latch an input signal based on a rising or falling edge of an input clock signal.

During the simulation of a digital design incorporating such asynchronous clock signals, the effects of the metastability encountered when incoming data needs to cross, for example, from the launching clock domain, to the receiving clock domain must be modeled. Normally, this interface is simply “designed” and considered to be working when the signals are protected by a metastability protection circuit. The metastability protection circuit should provide a sufficient MTBF such that the probability for metastability occurring is sufficiently small.

While such metastability protection circuits effectively reduce the likelihood of encountering a metastable state, a number of limitations exist that, if resolved, could further improve the utility of such metastability protection circuits. In particular, while the MTBF calculation for metastability provides significant assurance that the circuit will work, another, very important issue remains untested. There is currently little, if any, understanding of the effects caused by metastability protection circuits to the overall digital design. A metastability protection circuit can affect how long it may take for a signal that crosses from one clock domain to an independent clock domain to become stable and usable. In some systems, however, the amount of time added by the metastability protection circuit can cause a problem if the interface is time-dependent. Metastability, for example, could cause a signal to transition in a much longer time frame than initially intended. A need therefore exists for methods and apparatus for simulating the effects of the variable delays caused by metastability protection circuits.

### SUMMARY OF THE INVENTION

Generally, methods and apparatus are provided for modeling signal delays in a metastability protection circuit. According to one aspect of the invention, a metastability protection circuit that processes a signal that crosses between two clock domains is modeled by introducing a random transition delay into the signal upon detection of an edge in the signal. Thereafter, an effect of the random transition delay on one or more downstream logic elements can be evaluated. The random transition delay simulates a timing effect of a metastable state.

According to a further aspect of the invention, the random transition delay can optionally be introduced only during a simulation stage of the metastability protection circuit. For example, the metastability protection circuit can be defined using a Register Transfer Language and the Register Transfer Language includes one or more statements that selectively allow the introducing step.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional metastability protection circuit;

FIG. 2 illustrates a metastability protection circuit incorporating features of the present invention;

FIG. 3 illustrates the random circuit of FIG. 2 in further detail;

FIGS. 4A and 4B, collectively, illustrate exemplary Verilog Register Transfer Language code incorporating features of the present invention; and

FIG. 5 is a flow chart describing an exemplary signal delay modeling process incorporating features of the present invention.

### DETAILED DESCRIPTION

FIG. 1 illustrates a conventional metastability protection circuit 120. As shown in FIG. 1, a signal associated with a first clock domain, CLKₐ, is applied to a first flip flop 110, for example, in a launching clock domain. The incoming signal needs to cross, for example, from the launching clock domain, CLKₐ, to a receiving clock domain, CLK_{b}. As indicated above, the clock signals of the launching clock domain, CLKₐ, and the receiving clock domain, CLK_{b}, may be different frequencies or have the same frequency. The phase relationship between these clock signals, however, is often unknown (i.e., the clock signals are asynchronous). The two frequency clocks, CLKₐ and CLK_{b}, are normally simulated to be clocks with a common frequency factor. For example, CLKₐ can have a frequency of 5 MHz, while CLK_{b} has a frequency of 10 MHz. In an actual environment, however, these clocks could be 5 MHz and 7 MHz, or 5 MHz and 5.2 MHz

In order to prevent metastability during the cross-over, a metastability protection circuit 120 is often employed. The exemplary metastability protection circuit 120 comprises one or more D type flip-flops 130-1 and 130-2. As shown in FIG. 1, the D type flip-flops 130 include one input signal D, an output signal Q, and one clock signal CLK. The D type flip-flops 130-1 and 130-2 latch the input signal based on a rising or falling edge of an input clock signal.

As previously indicated, the metastability protection circuit 120 reduces the likelihood of encountering a metastable state. There is currently little, if any, understanding of the effects caused by metastability protection circuit 120 to the overall digital design.

The present invention provides methods and apparatus for simulating the effects of the variable delays caused by the metastability protection circuit 130 of FIG. 1. The present invention allows the behavior of a digital design to be observed by introducing a random transition delay. The random transition delay associated with the metastability protection circuit 120 can thus be introduced during a simulation stage so the effects of the random transition delay can be evaluated on the downstream logic. The disclosed randomization logic allows a designer to simulate the timing effects of metastability in such a way that the delay effects that might be caused by metastablity can better be simulated, and as such, make for a more robust and error free design.

According to a further aspect of the invention, the randomizer logic employed to simulate a random transition delay is only present during a simulation stage and is removed from the end product. Thus, in the exemplary embodiment described herein, the disclosed randomization logic can be switched on and off, and also, is designed, for example, in Register Transfer Language (RTL) such that it poses no problem for a synthesis tool chosen by the design team.

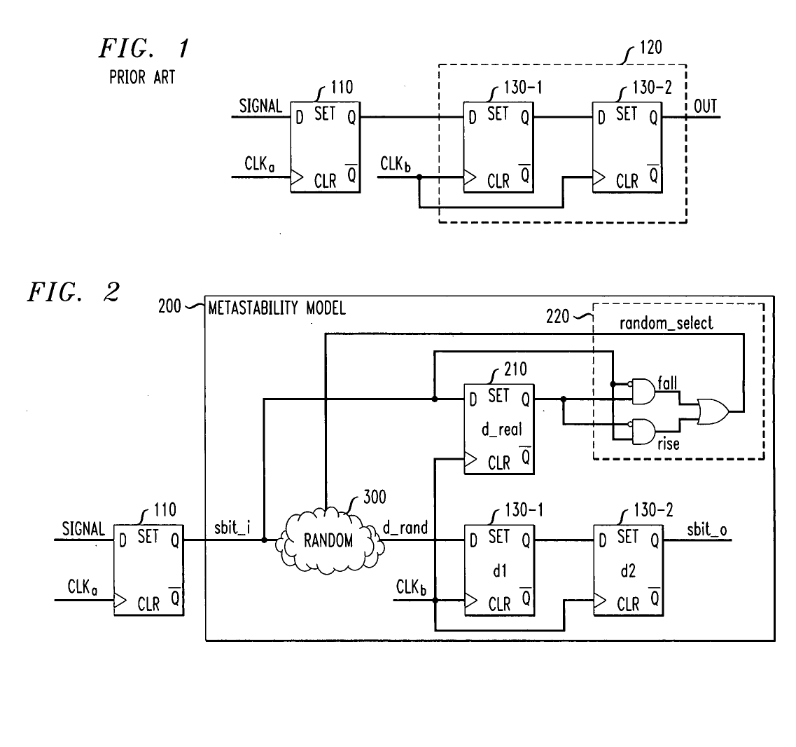

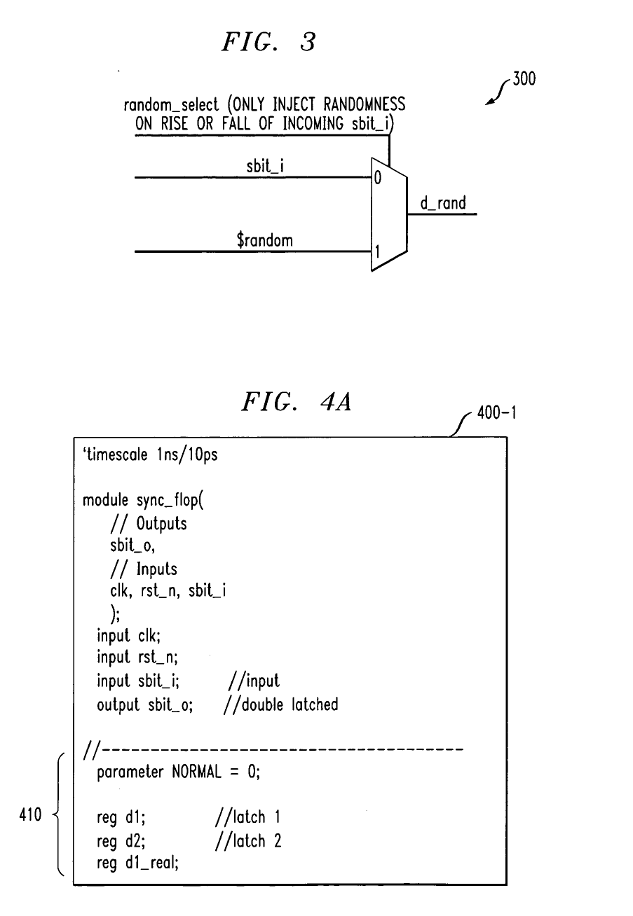

FIG. 2 illustrates a metastability protection circuit 200 incorporating features of the present invention. The exemplary D type flip flops 110, 130-1 and 130-2 shown in FIG. 2 operate in a similar manner to those described above in conjunction with FIG. 1. As shown in FIG. 2, the exemplary metastability protection circuit 200 includes a random circuit 300, discussed further below in conjunction with FIG. 3, a D type flip flop 210 and an edge detection circuit 220. Generally, the random transition delay is generated by the random circuit 300 based upon the detection of an edge by the edge detection circuit 220. The input signal sbit_i is applied to the D input of the D type flip flop 210 that is clocked by the receiving clock domain, CLK_{b}. The flip flop 210 captures the input signal sbit_i. The previous, and current values of the input signal sbit_i are compared on either side of the flip flop 210 so that the rise/fall signal that controls the random transition delay injection knows when to operate.

The exemplary logic shown in the edge detection circuit 220 comprises a pair of AND gates, each having one inverted input and an OR gate. Each AND gate processes the input and output values of the flip flop 210. The upper AND gate is configured to detect a falling edge on sbit_i (input is low and output is high) and the lower AND gate is configured to detect a rising edge on sbit_i (input is high and output is low). Whenever the value on the D input (sbit_i) of flip flop 210 differs from the Q output of flip flop 210, one of the AND gates will have a high output value and then the output of the OR gate will be high. The output of the edge detection circuit 220, random_select, is applied to the random circuit 300 of FIG. 3.

In one exemplary implementation, the random circuit 300, D type flip flop 210 and edge detection circuit 220 portions of the metastability protection circuit 200 are only present during a simulation stage and are removed during synthesis of the RTL to gates.

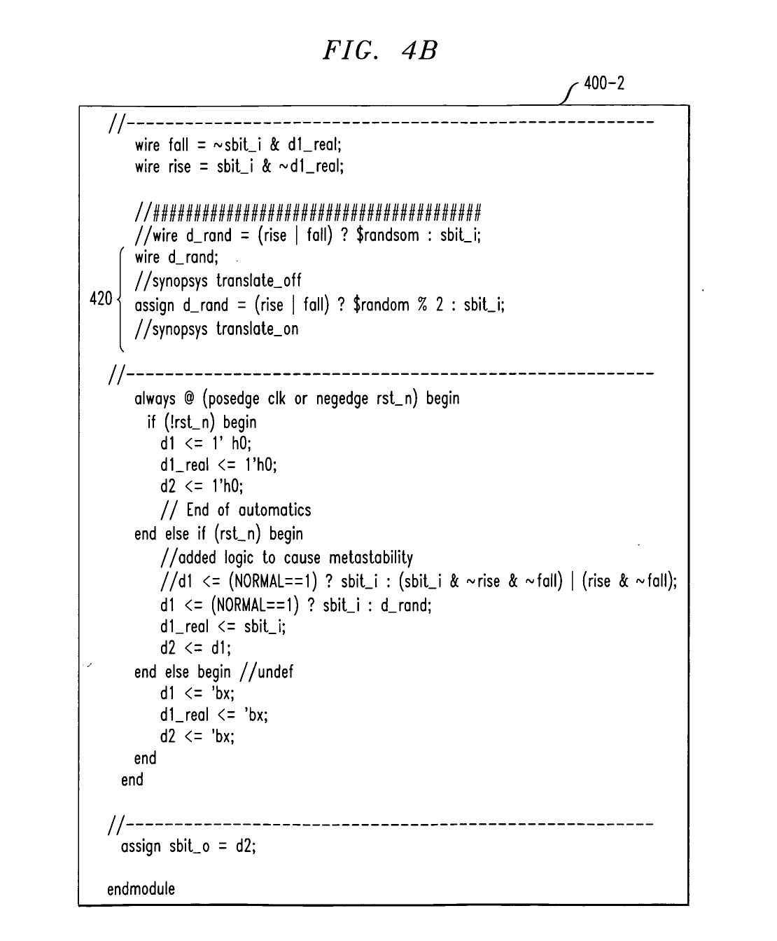

FIG. 3 illustrates the random circuit 300 of FIG. 2 in further detail. Generally, the random circuit 300 ensures that a random transition delay is only introduced upon detection of an edge by the edge detection circuit 220 of FIG. 2. As shown in FIG. 3, the exemplary random circuit 300 is a multiplexer that selects the sbit_i input shown in FIG. 2 unless an edge is detected by the edge detection circuit 220. When an edge is detected by the edge detection circuit 220, the multiplexer 300 selects the “1” input which receives a pseudo random value of 1 or 0 generated by a $random function. The $random function is discussed further below in conjunction with FIG. 4B. The random circuit 300 thus adds a random transition delay to the incoming control signal that crosses between two clock domains. In this manner, the timing variations inherent in clock domain crossing metastability protection circuits can be simulated.

FIGS. 4A and 4B, collectively, illustrate exemplary Verilog RTL code 400 incorporating features of the present invention. The exemplary code 400 is synthesizable with the Synopsys DesignCompiler software. The code 400 defines an exemplary embodiment of the randomized delay metastability protection circuit 200 of FIG. 2.

As previously indicated, the random circuit 300, D type flip flop 210 and edge detection circuit 220 portions of the metastability protection circuit 200 are only present during a simulation stage. The random circuit 300, D type flip flop 210 and edge detection circuit 220 can be removed during synthesis of the RTL by setting the parameter NORMAL in portion 410 of the code 400 to ‘1’. Likewise, in order to get the randomizing logic to work, the parameter NORMAL in portion 410 should be set to ‘0’ during simulation of the circuit. In this manner, the flip flop d1_real (210), for example, is part of the circuit during simulation. As shown in FIG. 4B, a portion 420 of the code 400 defines the operation of the random circuit 300 that introduces the random transition delay upon detection of a transition of sbit_i during a simulation.

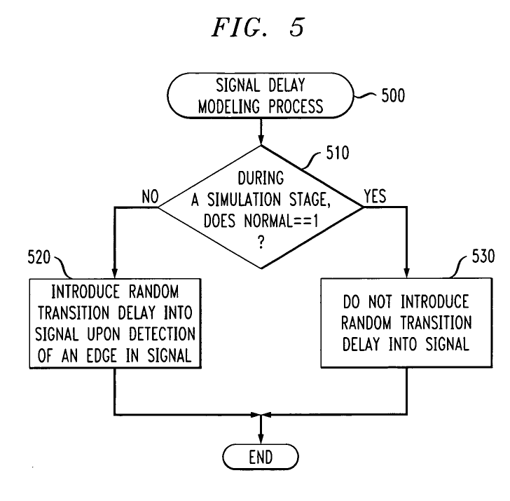

FIG. 5 is a flow chart describing an exemplary signal delay modeling process 500 incorporating features of the present invention. As shown in FIG. 5, the signal delay modeling process 500 initially performs a test during step 510 to determine if during a simulation state, the value of NORMAL is set to ‘1’ indicating that the random delay should be removed, for example, during synthesis.

If it is determined during step 510 that the value of NORMAL is not set to ‘1,’ then a random transition delay is introduced into the signal during step 520 upon detection of an edge in the signal. If, however, it is determined during step 510 that the value of NORMAL is set to ‘1,’ then a random transition delay is not introduced into the signal during step 530.

While exemplary embodiments of the present invention have been described with respect to digital logic blocks, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits.

It is to be understood that the embodiments and variations shown and described herein are merely illustrative of the principles of this invention and that various modifications may be implemented by those skilled in the art without departing from the scope and spirit of the invention.

We claim:

1. A method for simulating a metastability protection circuit that processes a signal that crosses between two clock domains, comprising:
introducing a random transition delay into said signal upon detection of an edge in said signal.

2. The method of claim 1, further comprising the step of evaluating an effect of said random transition delay on one or more downstream logic elements.

3. The method of claim 1, wherein said random transition delay simulates a timing effect of a metastable state.

4. The method of claim 1, wherein said random transition delay is only introduced during a simulation stage of said metastability protection circuit.

5. The method of claim 1, further comprising the step of defining said metastability protection circuit using a Register Transfer Language and wherein said Register Transfer Language includes one or more statements that selectively allow said introducing step.

6. The method of claim 1, wherein said two clock domains have synchronized clocks on two sides of an unsynchronized interface.

7. The method of claim 1, wherein said two clock domains have different frequencies.

8. A metastability protection circuit that processes a signal that crosses between two clock domains, comprising:
an edge detection circuit that detects an edge in said signal; and
a randomizing circuit introducing a random transition delay into said signal upon detection of an edge in said signal.

9. The metastability protection circuit of claim 8, wherein an effect of said random transition delay on one or more downstream logic elements is evaluated.

10. The metastability protection circuit of claim 8, wherein said random transition delay simulates a timing effect of a metastable state.

11. The metastability protection circuit of claim 8, wherein said edge detection circuit and said randomizing circuit are only active in said metastability protection circuit during a simulation stage of said metastability protection circuit.

12. The metastability protection circuit of claim 8, wherein said metastability protection circuit is defined using a Register Transfer Language and wherein said Register Transfer Language includes one or more statements that selectively allow said introduction of said random transition delay.

13. The metastability protection circuit of claim 8, wherein said two clock domains have synchronized clocks on two sides of an unsynchronized interface.

14. The metastability protection circuit of claim 8, wherein said two clock domains have different frequencies.

15. A design system for simulating a metastability protection circuit that processes a signal that crosses between two clock domains, comprising:
a memory; and
at least one processor, coupled to the memory, operative to:
introduce a random transition delay into said signal upon detection of an edge in said signal.

16. The design system of claim 15, processor is further configured to evaluate an effect of said random transition delay on one or more downstream logic elements.

17. The design system of claim 15, wherein said random transition delay simulates a timing effect of a metastable state.

18. The design system of claim 15, wherein said random transition delay is only introduced during a simulation stage of said metastability protection circuit.

19. The design system of claim 15, wherein said metastability protection circuit is defined using a Register Transfer Language and wherein said Register Transfer Language includes one or more statements that selectively allow said introducing step.

20. The design system of claim 15, wherein said two clock domains have synchronized clocks on two sides of an unsynchronized interface.
